(19) United States
(12) Patent Application Publication
(10) Pub. No.: US 2018/0160457 A1
(43) Pub. Date: Jun. 7, 2018

(54) WIRELESS PAIRING METHOD AND SYSTEM

(71) Applicant: Primax Electronics Ltd., Taipei (TW)

(72) Inventor: Chih-Feng Chien, Taipei (TW)

(21) Appl. No.: 15/424,894

(22) Filed: Feb. 6, 2017

(30) Foreign Application Priority Data
Dec. 2, 2016 (TW) 105139908

(51) Int. Cl. H04W 76/02; H04B 17/318; H04W 72/02; H04W 68/00; H04W 12/04

(52) U.S. Cl. CPC H04W 76/023; H04B 17/318; H04B 5/0062; H04W 68/00; H04W 12/04; H04W 72/02

(57) ABSTRACT

A wireless pairing system includes a signal receiver, a signal transmitter and a host device. The signal receiver includes a first wired connection port and a first wireless connection port. The signal transmitter includes a second wired connection port and a second wireless connection port. The host device is connected with the first wired connection port of the signal receiver and the second wired connection port of the signal transmitter. After a wired connection between the signal receiver and the host device and a wired connection between the signal transmitter and the host device are established, the signal receiver and the signal transmitter are paired with each other through the host device. Consequently, a wireless communication between the first wireless connection port and the second wireless connection port is enabled.

### BACKGROUND OF THE INVENTION

### 1. Field of the Invention

The present invention relates to a wireless pairing method and a wireless pairing system, and more particularly to a wireless pairing method and a wireless pairing system with high security.

### 2. Description of the Prior Art

With increasing development of science and technology, various wireless devices such as wireless mouse devices, wireless keyboards, wireless graphics boards or wireless microphones are widely used in daily lives. The wireless devices use electromagnetic waves to transmit signals. In comparison with the wired devices, the uses of the wireless devices can reduce the cost of cables (or connecting wires). Moreover, the uses of the wireless devices can reduce the storage space and increase the operating distance. Recently, the wired devices are gradually replaced by the wireless devices.

Nowadays, a pairing technology is employed to transfer pairing information between wireless devices in a wireless communication manner. For example, a wireless mouse issues a wireless signal to a USB dongle in order to request a wireless pairing process. Since the wireless signal is transmitted in a broadcasting form, the pairing process of utilizing the wireless signal has some drawbacks. For example, the relevant pairing information is easily captured by the persons with bad intentions through a skimming method or a data simulation method, and then the data of the wireless device are stolen or destroyed through the pairing information. In other words, the uses of the wireless devices have potential security problems.

In addition to the security problem, the wireless devices also face a signal interference problem. Generally, the wireless devices are in communication with each other through a wireless signal at a specified frequency. For example, the center frequency of the wireless signal is 2.4 GHz. If many wireless devices are used simultaneously, the wireless channels are easily occupied. When the wireless channels are occupied, the wireless signal is interfered. If the signal interference problem is serious, the wireless devices cannot be operated normally.

### SUMMARY OF THE INVENTION

In accordance with an aspect of the present invention, there is provided a wireless pairing system. The wireless pairing system includes a signal receiver, a signal transmitter and a host device. The signal receiver includes a first wired connection port and a first wireless connection port. The signal transmitter includes a second wired connection port and a second wireless connection port. The host device is connected with the first wired connection port of the signal receiver and the second wired connection port of the signal transmitter. After a wired connection between the signal receiver and the host device and a wired connection between the signal transmitter and the host device are established, the signal receiver and the signal transmitter are paired with each other through the host device. Consequently, a wireless communication between the first wireless connection port and the second wireless connection port is enabled.

In accordance with another aspect of the present invention, there is provided a wireless pairing method. Firstly, a signal receiver is connected with a host device through a first wired connection port, and a signal transmitter is connected with the host device through a second wired connection port. Then, at least one first wireless communication parameter of the signal receiver is recognized, and at least one second wireless communication parameter of the signal transmitter is recognized. After the at least one first wireless communication parameter is compared with the at least one second wireless communication parameter, at least one paired wireless communication parameter is generated. Then, the at least one paired wireless communication parameter is stored in the signal receiver and the signal transmitter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic functional block diagram illustrating the architecture of a wireless pairing system according to an embodiment of the present invention;

FIG. 2 is a flowchart illustrating a wireless pairing method implemented by the wireless pairing system of the present invention;

FIG. 3 is a flowchart illustrating a channel setting process implemented by the wireless pairing system of the present invention; and

FIG. 4 is a plot illustrating the relationship between the RSSI information and the selected wireless channels of plural available wireless channels.

### DETAILED DESCRIPTION

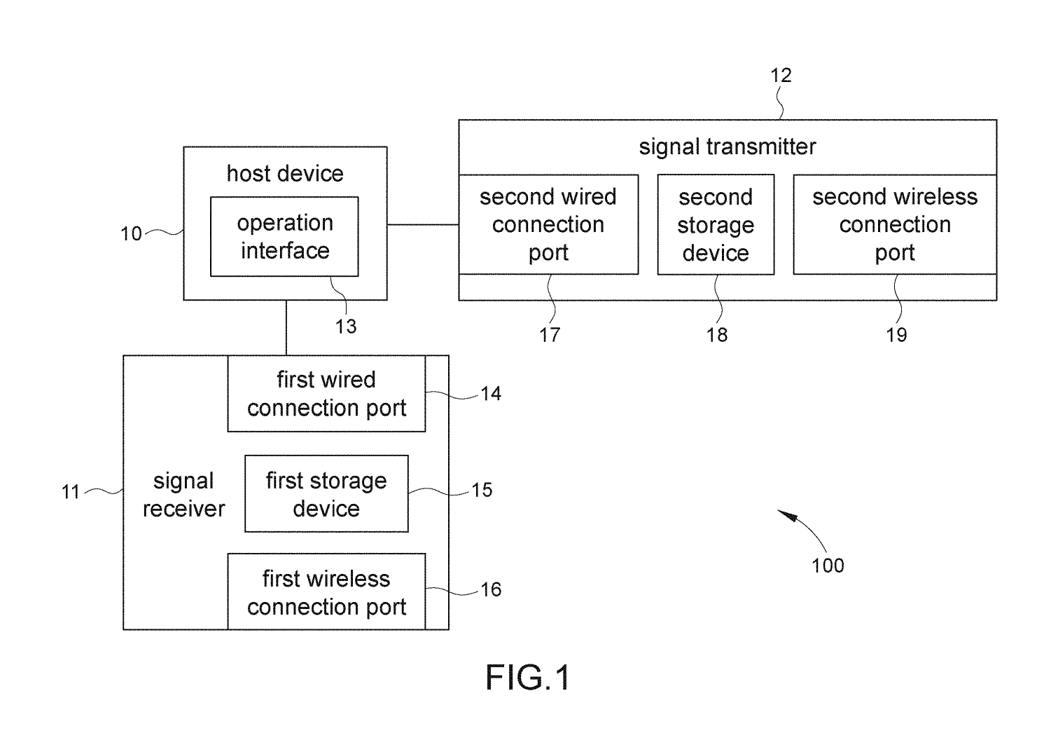

FIG. 1 is a schematic functional block diagram illustrating the architecture of a wireless pairing system according to an embodiment of the present invention. As shown in FIG. 1, the wireless pairing system 100 comprises a host device 10, a signal receiver 11 and a signal transmitter 12.

The host device 10 is an electronic device with any software execution function or a programmable logic operation function. For example, the host device 10 is a computer, a workstation or a smart phone.

The signal receiver 11 comprises a first wired connection port 14, a first storage device 15 and a first wireless connection port 16. The signal receiver 11 is a wireless network transceiver with a universal serial bus (USB) interface. For example, the signal receiver 11 is a USB dongle. The first wired connection port 14 is a USB port. It is noted that the first wired connection port is not restricted to the USB port. For example, a Micro-USB port, a RJ45 port, a Mini-USB or any other appropriate connection port can be used as the first wired connection port 14. The first storage device 15 is a memory device with read/write functions. For example, the first storage device 15 is a hard disc, a non-volatile memory or any other appropriate memory device. The first wireless connection port 16 is a signal receiving terminal with a network transmission function. Moreover, the first wireless connection port 16 supports any type of electromagnetic signal. For example, the first wireless connection port 16 can receive an electromagnetic signal at a frequency of 2.4G.

The signal transmitter 12 is any electronic device with the function of emitting signals. For example, the signal transmitter 12 is a wireless mouse, a wireless keyboard or a wireless digital graphics board. In this embodiment, the signal transmitter 12 comprises a second wired connection port 17, a second storage device 18 and a second wireless connection port 19. The second wired connection port 17 is a USB port. Like the first wired connection port 14, a Micro-USB port, a RJ45 port, a Mini-USB or any other appropriate connection port can be used as the second wired connection port 17. The second storage device 18 is a memory device with read/write functions. For example, the second storage device 18 is a hard disc, a non-volatile memory or any other appropriate memory device. The second wireless connection port 19 is a signal transmitting terminal with a network transmission function. Moreover, the second wireless connection port 19 supports any type of electromagnetic signal. For example, the second wireless connection port 19 can receive an electromagnetic signal at a frequency of 2.4G.

In the wireless pairing system 100, the host device 10 is connected with the first wired connection port 14 of the signal receiver 11 and the second wired connection port 17 of the signal transmitter 12. In other words, the host device 10 is connected with the signal receiver 11 and the signal transmitter 12 in a wired communication manner. Moreover, the host device 10 comprises an operation interface 13. After the signal receiver 11 and the signal transmitter 12 are connected with the host device 10 in the wired communication manner, the host device 10 performs a pairing process to pair the signal receiver 11 and the signal transmitter 12 with each other. Consequently, the wireless communication functions of the first wireless connection port 16 and the second wired connection port 17 are enabled. When the host device 10 performs the pairing process to pair the signal receiver 11 and the signal transmitter 12 with each other, the pairing process is automatically implemented through the execution of software or application program.

Alternatively, by inputting user-defined paring parameters into the operation interface 13, the pairing process can be manually implemented. While the pairing process of the wireless pairing system 100 is performed, the wireless communication parameters carried by the signal receiver 11 and the signal transmitter 12 are inputted into the host device 10 in the wired communication manner. That is, no wireless signal is broadcasted. Consequently, the wireless pairing system 100 can largely reduce the possibility of leaking the wireless communication parameters. A wireless pairing method of the wireless pairing system 100 will be described as follows.

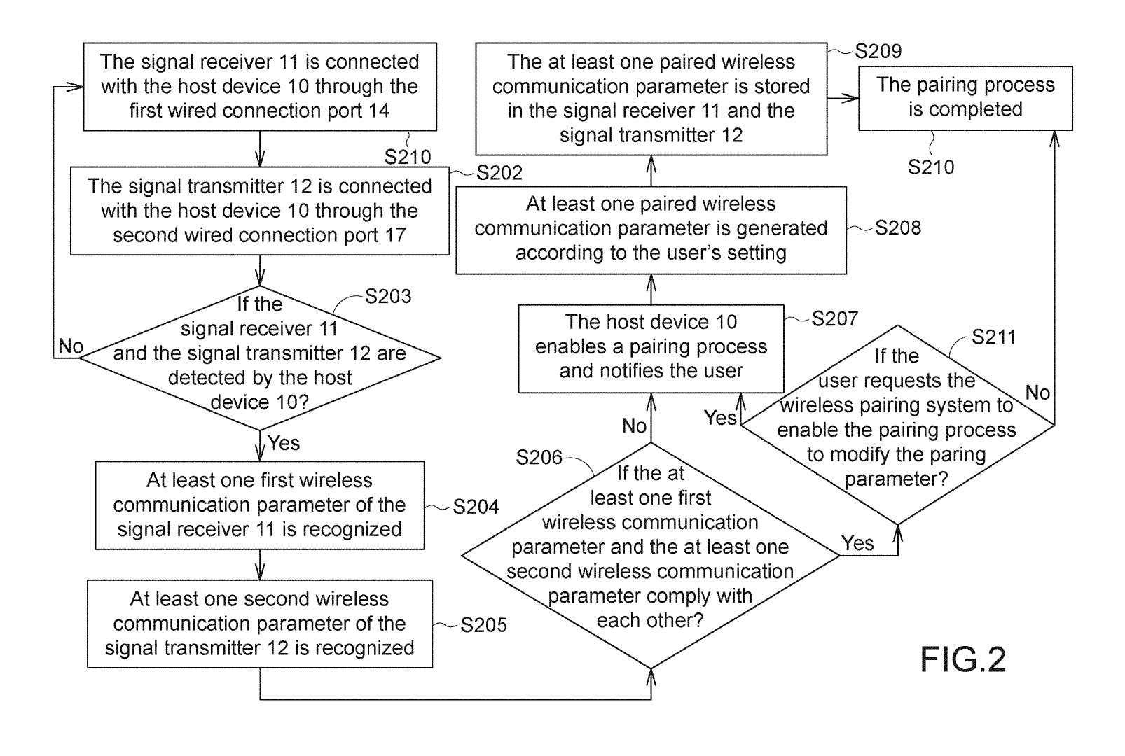

FIG. 2 is a flowchart illustrating a wireless pairing method implemented by the wireless pairing system of the present invention. The wireless pairing method comprises steps S201˜S211. It is noted that the sequence of the steps S201˜S211 is not restricted. For example, the sequence of the steps S201 and S202 may be exchanged, or the sequence of the steps S204 and S205 may be exchanged. Moreover, numerous modifications and alterations may be made while retaining the teachings of the invention. That is, some steps may be added to or omitted from the wireless pairing method according to the practical requirements. The steps S201˜S211 will be described as follows.

In the step S201, the signal receiver 11 is connected with the host device 10 through the first wired connection port 14.

In the step S202, the signal transmitter 12 is connected with the host device 10 through the second wired connection port 17.

In the step S203, the host device 10 judges whether the signal receiver 11 and the signal transmitter 12 are detected. If the judging result of the step S203 is satisfied, the step S204 is performed. If the judging result of the step S204 is not satisfied, the step S201 is repeatedly done.

In the step S204, at least one first wireless communication parameter of the signal receiver 11 is recognized.

In the step S205, at least one second wireless communication parameter of the signal transmitter 12 is recognized.

The step S206 is performed to judge whether the at least one first wireless communication parameter and the at least one second wireless communication parameter comply with each other. If the judging result of the step S206 is satisfied, the step S211 is performed. If the judging result of the step S206 is not satisfied, the step S207 is performed.

In the step S207, the host device 10 enables a pairing process and notifies the user.

In the step S208, at least one paired wireless communication parameter is generated according to the user's setting.

In the step S209, the at least one paired wireless communication parameter is stored in the signal receiver 11 and the signal transmitter 12.

In the step S210, the pairing process is completed.

The step S211 is performed to judge whether the user requests the wireless pairing system to enable the pairing process to modify the paring parameter. If the judging result of the step S211 is satisfied, the step S207 is performed. If the judging result of the step S211 is not satisfied, the step S210 is performed and the pairing process is completed.

In the step S201, the signal receiver 11 is connected with the host device 10 through the first wired connection port 14. For example, the signal receiver 11 (e.g., the USB dongle) is connected with the host device 10 by the user through the USB port. In the step S202, the signal transmitter 12 is connected with the host device 10 through the second wired connection port 17. For example, the wireless mouse is connected with the host device 10 by the user through the USB port. In this embodiment, the signal receiver 11 and the signal transmitter 12 have dual mode transmission functions. That is, the signal receiver 11 and the signal transmitter 12 have the functions of using the wired connection ports to connect with the host device 10 to transfer data. Moreover, the signal receiver 11 and the signal transmitter 12 have the functions of using the wireless connection ports to transfer data. When the signal receiver 11 and the signal transmitter 12 are connected with the host device 10 in the wired communication manner, the software or application program in the host device 10 detects the signal receiver 11 and the signal transmitter 12 and judges whether the signal receiver 11 and the signal transmitter 12 are connected with the host device 10 (Step S203).

If the signal receiver 11 and the signal transmitter 12 cannot be detected or recognized, it means that the wired connection ports of the signal receiver 11 and the signal transmitter 12 have malfunctions. For example, in case that the wired connection ports are in a poor contact condition, a rusty condition or a damaged condition, the wired connection ports have the malfunctions. Under this circumstance, the steps S201 and S202 are repeatedly performed to allow the signal receiver 11 and the signal transmitter 12 to be connected with the host device 10.

Moreover, the steps S201˜S203 may be reasonably modified. For example, if the signal receiver 11 is detected by the host device 10 but the signal transmitter 12 is not detected by the host device 10, the step S202 is repeatedly performed to allow the signal transmitter 12 to be connected with the host device 10 but the step S201 is not performed again. Alternatively, if the signal transmitter 12 is detected by the host device 10 but the signal receiver 11 is not detected by the host device 10, the step S202 is repeatedly performed to allow the signal receiver 11 to be connected with the host device 10 but the step S202 is not performed again.

After both of the signal receiver 11 and the signal transmitter 12 are detected by the host device 10, the steps S204 and S205 are performed. That is, at least one wireless communication parameter of the signal receiver 11 and at least one wireless communication parameter of the signal transmitter 12 are recognized by the host device 10. For avoiding confusion, the wireless communication parameter of the signal receiver 11 is referred as a first wireless communication parameter, and the wireless communication parameter of the signal transmitter 12 is referred as a second wireless communication parameter. The first wireless communication parameter and the second wireless communication parameter are radio frequency identification parameters, link keys, advanced encryption standard keys, serial numbers or wireless channel parameters.

After the at least one wireless communication parameter of the signal receiver 11 and at least one wireless communication parameter of the signal transmitter 12 are read out by the host device 10, the step S206 is performed. That is, the host device 10 judges whether the at least one first wireless communication parameter and the at least one second wireless communication parameter comply with each other. If the at least one first wireless communication parameter and the at least one second wireless communication parameter do not comply with each other, it means that the signal receiver 11 and the signal transmitter 12 are not paired with each other. Then, the step S207 is performed. That is, the host device 10 enables a pairing process and notifies the user.

On the other hand, if the at least one first wireless communication parameter and the at least one second wireless communication parameter comply with each other, it means that the signal receiver 11 and the signal transmitter 12 are paired with each other. Then, the step S211 is performed to judge whether the user requests the wireless pairing system to enable the pairing process to modify the paring parameter. If the judging result of the step S211 is satisfied, the step S207 is performed. If the judging result of the step S211 is not satisfied, the step S210 is performed and the pairing process is completed.

In other words, there are two approaches of entering the step S207 to enable the pairing process. In accordance with the first approach, the pairing process is enabled if the first wireless communication parameter and the second wireless communication parameter do not comply with each other. In accordance with the second approach, the pairing process is enabled if the first wireless communication parameter and the second wireless communication parameter comply with each other but the user requests the wireless pairing system to enable the pairing process to modify the pairing parameter. If the user does not request the wireless pairing system to enable the pairing process in the step S211, the step S210 is performed and the flowchart is ended. After the pairing process is enabled in the step S207, the host device 10 generates at least one paired wireless communication parameter according to the user's setting in the step S208. As mentioned above, the host device 10 can enable the pairing process through an application program. Consequently, the at least one paired wireless communication parameter is automatically generated through the application program. The at least one paired wireless communication parameter includes the radio frequency identification parameter, the link key, the advanced encryption standard key, the serial number or the wireless channel parameter. Then, in the step S209, the at least one paired wireless communication parameter is stored in the first storage device 15 of the signal receiver 11 and the second storage device 18 of the signal transmitter 12. Then, in the step S210, the paring process is completed.

After the paring process is completed, the paired wireless communication parameter is stored in the signal receiver 11 and the signal transmitter 12. Afterwards, the wireless communication functions of the signal receiver 11 and the signal transmitter 12 are directly enabled to wirelessly transfer data. In the steps S201˜S211, the steps of detecting the signal receiver 11 and the signal transmitter 12 by the host device 10, the steps of recognizing the at least one first wireless communication parameter and the at least one second wireless communication parameter by the host device 10 and the step of generating the at least one paired wireless communication parameter by the host device 10 according to the user's setting are all implemented in wired communication manner. That is, no wireless signal is broadcasted. Consequently, the wireless pairing system 100 can largely reduce the possibility of leaking the wireless communication parameters.

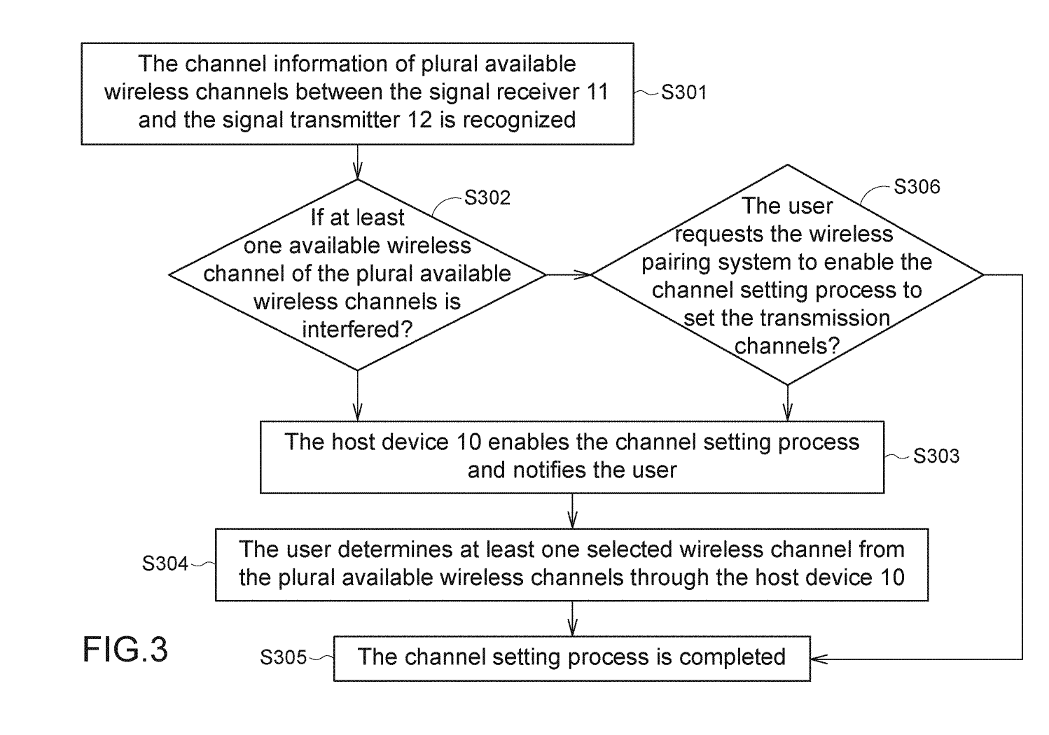

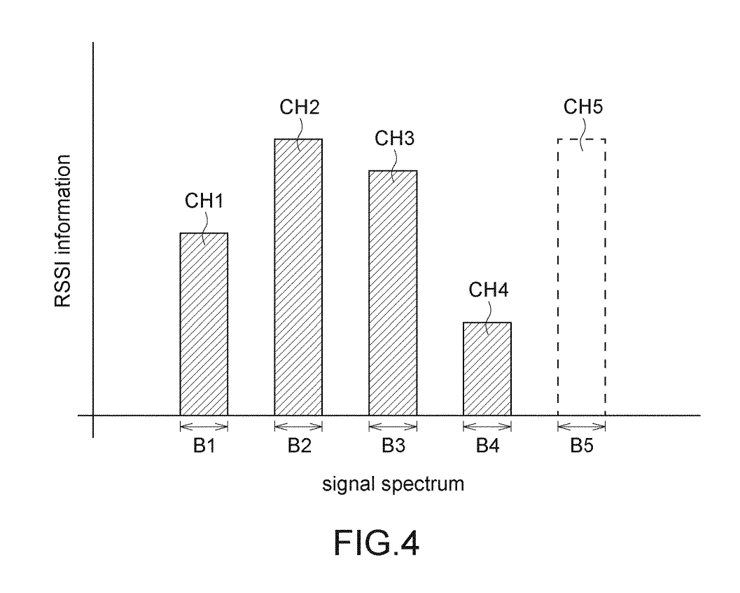

FIG. 3 is a flowchart illustrating a channel setting process implemented by the wireless pairing system of the present invention. FIG. 4 is a plot illustrating the relationship between the RSSI information and the selected wireless channels of plural available wireless channels. After the steps S201˜S211 of the wireless pairing method are completed, the possibility of leaking the wireless communication parameters can be largely reduced. For optimizing the wireless channel setting between the signal receiver 11 and the signal transmitter 12, the wireless pairing method of the present invention further provides a channel setting process. The channel setting process of FIG. 3 is performed after the step S210. After the wireless paring method of FIG. 2 and the channel setting process of FIG. 3 are performed, the possibility of leaking the wireless communication parameters of the signal receiver 11 and the signal transmitter 12 will be largely reduced and the wireless channel setting between the signal receiver 11 and the signal transmitter 12 will be optimized. Consequently, the wireless communication quality is enhanced. The channel setting process comprises steps S301˜S306. Moreover, some steps may be added to or omitted from the channel setting process according to the practical requirements. The steps S301˜S306 will be described as follows.

In the step S301, the channel information of plural available wireless channels between the signal receiver 11 and the signal transmitter 12 is recognized by the host device 10.

The step S302 is performed to judge whether at least one available wireless channel of the plural available wireless channels is interfered. If the judging result of the step S302 is satisfied, the step S303 is performed. If the judging result of the step S303 is satisfied, the step S306 is performed

In the step S303, the host device 10 enables the channel setting process and notifies the user.

In the step S304, the user determines at least one selected wireless channel from the plural available wireless channels through the host device 10.

In the step S305, the channel setting process is completed.

The step S306 is performed to judge whether the user requests the wireless pairing system to enable the channel setting process to set the transmission channels. If the judging result of the step S306 is satisfied, the step S303 is performed. If the judging result of the step S306 is not satisfied, the step S305 is performed.

The above steps will be described in more details as follows.

In the step S301, the channel information of the plural available wireless channels between the signal receiver 11 and the signal transmitter 12 is recognized by the host device 10. For example, as shown in FIG. 4, plural default wireless channels CH1˜CH4 between the signal receiver 11 and the signal transmitter 12 are recognized by the host device 10. The wireless channel CH1 has a spectrum B1. The wireless channel CH2 has a spectrum B2. The wireless channel CH3 has a spectrum B3. The wireless channel CH4 has a spectrum B4. Generally, the channel gains of some spectrum ranges in the wireless communication environment are possibly faded because of shadow effect or co-channel signal interference. Consequently, these wireless channels CH1˜CH4 have different received signal strength indicator (RSSI) information.

Then, in the step S302, the host device 10 judges whether at least one available wireless channel of the plural available wireless channels is interfered. In an embodiment, the above RSSI information, the signal-to-noise (SNR) ratio of pilot signals or any algorithm for judging whether the channel gains of wireless channels are faded can be used to judge the channel interference. For example, as shown in FIG. 4, the channel gain and the RSSI information of the wireless channel CH4 are largely faded because of larger channel interference. Consequently, in the step S303, the host device 10 enables the channel setting process and notifies the user. On the other hand, if the plural wireless channels are not interfered, the step S306 is performed. The host device 10 inquires whether the user requests the wireless pairing system to enable the channel setting process to set the transmission channels. If the judging result of the step S306 is satisfied, the step S303 is performed. If the judging result of the step S306 is not satisfied, the step S305 is performed.

In other words, there are two approaches of entering the step S303 to enable the channel setting process. In accordance with the first approach, the channel setting process is enabled by the host device 10 if at least one available wireless channel of the plural available wireless channels is interfered. In accordance with the second approach, the channel setting process is enabled by the host device 10 if the plural wireless channels are not interfered and the user requests the wireless pairing system to enable the channel setting process.

In the step S304, the user determines at least one selected wireless channel from the plural available wireless channels through the host device 10. For example, as shown in FIG. 4, the user may select the wireless channel CH2 from the plural available wireless channels CH1˜CH4 because the channel interference of the wireless channel CH2 is the lowest. Moreover, the step S304 may be modified to avoid using any interfered wireless channel. For example, if all of the available wireless channels are seriously interfered, the user may set a new wireless channel CH5 (see FIG. 4) and set the corresponding spectrum B5. Then, the new wireless channel CH5 with the spectrum B5 is selected. After at least one wireless channel is selected in the step S304, the at least one selected wireless channel is applied to wireless transmission between the signal receiver 11 and the signal transmitter 12. Then, the channel setting process is completed in the step S305.

After the steps S301˜S306 are completed, the spectrum of the serially-interfered wireless channel will not be employed by the signal receiver 11 and the signal transmitter 12 to transfer signals. Even if all default wireless channels are seriously interfered, the user can set the spectrum of the wireless channel. Consequently, the received signal strength is not seriously distorted. In other words, the steps S301˜S306 of the channel setting process assures the quality of the wireless transmission between the signal receiver 11 and the signal transmitter 12. Consequently, the operating reliability of the signal receiver 11 and the signal transmitter 12 will be increased.

In the wireless pairing system 100 of the present invention, the signal receiver 11 and the signal transmitter 12 are paired with each other through the host device 10. In some other embodiments, the signal receiver 11 and the signal transmitter 12 are paired with each other in a self-pairing manner. For example, the signal transmitter comprises a receiving space. After the signal receiver 11 (e.g., a USB dongle) is accommodated within the receiving space of the signal transmitter 12 and the signal transmitter 12 is powered on, the signal receiver 11 and the signal transmitter 12 are paired with each other in a self-pairing manner through the built-in wired connection ports.

From the above descriptions, the present invention provides the wireless pairing method and the wireless pairing system. Both of the signal receiver and the signal transmitter are connected with the host device through wired connection ports. Through the execution of software or application program, the relevant pairing data of the signal receiver and the signal transmitter are acquired and compared with each other. If the pairing data comply with each other, it means that the signal receiver and the signal transmitter are paired with each other. Unless the user requests the wireless pairing system to modify the pairing parameter, the wireless pairing system does not take any additional action. If the pairing data do not comply with each other, the software or application program actively inquires whether the user requests the wireless pairing system to enable the pairing process. Moreover, an operation interface is provided for allowing the user to define the pairing parameter, or the software or application program is executed according to the default pairing parameter that is suggested by the system. Since all pairing steps are performed through wired data transmission without broadcasting any wireless signal, the host device is considered as a data transmission medium during the pairing process only. Consequently, the wireless pairing system of the present invention can largely reduce the possibility of leaking the wireless communication parameters. For reducing the possibility of wireless communication interference, the wireless pairing method further comprises the channel setting process. The software or application program in the host device can acquire the channel interface condition of the current available wireless channels. If some default channels are interfered and the device is unable to work, the wireless pairing system will actively notify the user to select the suitable channel for transferring signals. Through the execution of the software or application program, the suitable channel for transferring signals is selected directly or the wireless transmission channel is changed according to the system's suggestion. Consequently, the operating reliability of the signal receiver and the signal transmitter will be increased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless pairing system, comprising:
a signal receiver comprising a first wired connection port and a first wireless connection port;
a signal transmitter comprising a second wired connection port and a second wireless connection port; and
a host device connected with the first wired connection port of the signal receiver and the second wired connection port of the signal transmitter,
wherein after a wired connection between the signal receiver and the host device and a wired connection between the signal transmitter and the host device are established, the signal receiver and the signal transmitter are paired with each other through the host device, so that a wireless communication between the first wireless connection port and the second wireless connection port is enabled.

2. The wireless pairing system according to claim 1, wherein the host device comprises an operation interface, wherein at least one wireless communication parameter for performing the wireless communication between the first wireless connection port and the second wireless connection port is set through the operation interface.

3. The wireless pairing system according to claim 2, wherein the at least one wireless communication parameter includes a radio frequency identification parameter, a link key, an advanced encryption standard key, a serial number and/or a wireless channel parameter.

4. The wireless pairing system according to claim 2, wherein plural available wireless channels are shown on the operation interface, and at least one wireless channel is selected from the plural available wireless channels by a user through the operation interface.

5. The wireless pairing system according to claim 1, wherein the signal receiver further comprises a first storage device, and the signal transmitter comprises a second storage device, wherein at least one paired wireless communication parameter is stored in the first storage device and the second storage device.

6. A wireless pairing method, comprising steps of:
connecting a signal receiver with a host device through a first wired connection port;
connecting a signal transmitter with the host device through a second wired connection port;
recognizing at least one first wireless communication parameter of the signal receiver;
recognizing at least one second wireless communication parameter of the signal transmitter;
comparing the at least one first wireless communication parameter with the at least one second wireless communication parameter, thereby generating at least one paired wireless communication parameter; and
storing the at least one paired wireless communication parameter in the signal receiver and the signal transmitter.

7. The wireless pairing method according to claim 6, wherein if the at least one first wireless communication parameter and the at least one second wireless communication parameter do not comply with each other in the comparing step, the host device notifies a user to enable a pairing process, wherein after the pairing process is enabled, the host device generates at least one paired wireless communication parameter according to a setting of the user.

8. The wireless pairing method according to claim 6, wherein if the at least one first wireless communication parameter and the at least one second wireless communication parameter comply with each other in the comparing step and a user requests the wireless pairing system to enable a pairing process, the host device generates at least one paired wireless communication parameter according to a setting of the user.

9. The wireless pairing method according to claim 6, further comprising:
recognizing channel information of plural available wireless channels between the signal receiver and the signal transmitter;
determining at least one selected wireless channel from the plural available wireless channels according to the channel information of the plural available wireless channels; and
storing the channel information of the at least one selected wireless channel in the signal receiver and the signal transmitter.

10. The wireless pairing method according to claim 9, wherein the channel information of plural available wireless channels includes spectrum information and received signal strength indicator (RSSI) information of the plural available wireless channels.

11. The wireless pairing method according to claim 10, wherein if at least one of the plural available wireless channels is interfered, the host device notifies a user to enable a channel setting process, wherein after the channel setting process is enabled, the user is allowed to determine at least one selected wireless channel from the plural available wireless channels through the host device.

12. The wireless pairing method according to claim 10, wherein if all of the plural available wireless channels are not interfered and a user requests the wireless pairing system to enable channel setting process, the user is allowed to determine the at least one selected wireless channel from the plural available wireless channels through the host device.
